(19) United States
(12) Patent Application Publication
(10) Pub. No.: US 2002/0000365 A1
(43) Pub. Date: Jan. 3, 2002

(54) WATER DISTILLER

(76) Inventor: MR LONG-MING WANG, KAOHSIUNG (TW)

Correspondence Address: BACON & THOMAS, 625 SLATERS LANE 4TH FLOOR, ALEXANDRIA, VA, 223141176

(21) Appl. No.: 09/291,205

(22) Filed: Apr. 14, 1999

(30) Foreign Application Priority Data
Feb. 23, 1999 (TW) 88202909

(51) Int. Cl. B01D 3/00; B01D 3/14

(52) U.S. Cl. 202/185.5; 202/182; 202/185.3; 202/190

(57) ABSTRACT

A water distiller includes a shell, a container, a heater, a thermal conductive plate, a thermostat, a cover, a condenser coil, and a fan. The shell provides a compartment for receiving the container, the heater, the thermal conductive plate, and the thermostat. The container includes a bottom wall with an inclined surface to which the heater is connected. A higher end of the inclined surface is connected to the thermal conductive plate and the thermostat. The thermostat is mounted in a room provided between the shell and the container, and a first spring is provided to bias the thermostat to be in an intimate contact with cylindrical side wall of the container. A cap is mounted outside the room and a push button is mounted in the cap with an end exposed outside the cap for manual operation. A second spring is mounted in the cap for biasing the push button to a position for the manual operation. The cover mounted on top of the shell provides a compartment for receiving the condenser coil and the fan.

### BACKGROUND OF THE INVENTION

1. Field of the Invention

The present invention relates to a water distiller, and more particularly to an arrangement in the bottom wall of a container and a push button of a thermostat of the water distiller.

2. Description of the Related Art

U.S. Pat. No. 4,342,623 to Loeffler issued on Aug. 3, 1982 discloses a portable water distiller that includes a container and a cover mounted on top of the container. A sealing gasket is provided in the cover to be in contact with cylindrical wall of the container. The cover further includes air inlet and air outlet so as to allow air convection to the condenser coil and the fan. A tube conveys the steam from the container to the condenser coil. A heater is directly mounted to the bottom wall of the container in a manner that the thermostat opens in response to a sudden rise in the temperature of the container and the heating plate after the raw water in the container has been boiled to exhaustion. However, a conductive silicon layer applied between the heating plate of the heater and the container may malfunction as a result of overheating while the heating plate tends to deform at high temperature. Thus, the thermostat malfunctions easily, and scale tends to accumulate on the inner periphery of the container as a result of excessive heat.

The present invention is intended to provide an improved water distiller that mitigates and/or obviates the above problems.

### SUMMARY OF THE INVENTION

It is a primary object of the present invention to provide a water distiller with a bottom wall configured to avoid overheating of the container and the heating plate.

It is a secondary object of the present invention to provide a water distiller, wherein a spring is provided to reliably bias the thermostat to be in an intimate contact with a cylindrical wall of the container, thereby improving the contact between the thermostat and a thermal conductive plate of the container.

A water distiller in accordance with the present invention comprises a shell, a container, a heater, a thermal conductive plate, a thermostat, a cover, a condenser coil, and a fan. The shell provides a compartment for receiving the container, the heater, the thermal conductive plate, and the thermostat. The container includes a bottom wall with an inclined surface to which the heater is connected. A higher end of the inclined surface is connected to the thermal conductive plate and the thermostat. The thermostat is mounted in a room provided between the shell and the container, and a first spring is provided to bias the thermostat to be in an intimate contact with cylindrical side wall of the container. A cap is mounted outside the room and a push button is mounted in the cap with an end exposed outside the cap for manual operation. A second spring is mounted in the cap for biasing the push button to a position for the manual operation. The cover provides a compartment for receiving the condenser coil and the fan. The cover is mounted on top of the shell such that the shell and the cover together form an enclosed container. The container receives raw water which is vaporized by the heater, and the steam condenses by the condenser coil and the fan.

The overheating problem of the conventional water distiller is avoided in the water distiller of the present invention by means of provision of the inclined surface in the bottom wall of the container such that a pre-determined control temperature is reached and the power is shut off before the raw water in the container is boiled to exhaustion. Thus, overheating of the container and the thermal conductive plate is avoided. In addition, poor contact between the container and the thermostat is avoided by means of providing a spring to bias the thermostat toward the container.

Other objects, advantages, and novel features of the invention will become more apparent from the following detailed description when taken in conjunction with the accompanying drawings.

### BRIEF DESCRIPTION OF THE DRAWINGS

FIG. 1 is a longitudinal sectional view of a water distiller in accordance with the present invention;

FIG. 2 is an enlarged sectional view of an upper portion of the water distiller in accordance with the present invention;

FIG. 3 is an enlarged sectional view of a lower portion of the water distiller in accordance with the present invention, wherein the raw water in the container nearly boils to exhaustion; and

FIG. 4 is an enlarged view of a circle in FIG. 3.

### DETAILED DESCRIPTION OF THE PREFERRED EMBODIMENT

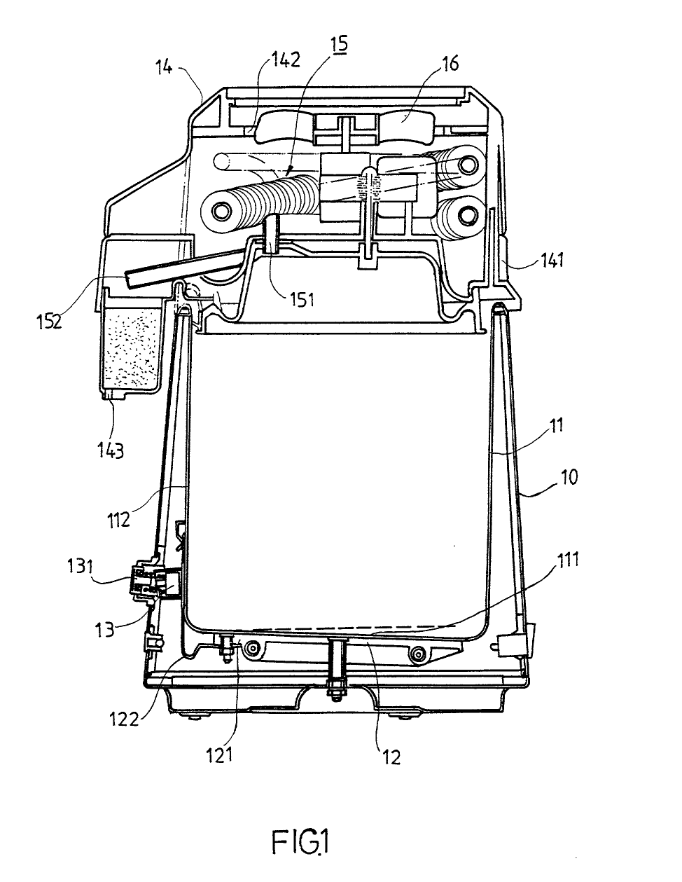

Referring to FIGS. 1 through 3, a water distiller in accordance with the present invention generally includes a shell 10, a container 11, a heater 12, a thermostat 13, a cover 14, a condenser coil 15, and a fan 16. The shell 10 includes a compartment for receiving the container 11, the heater 12, a thermal conductive plate 122, and the thermostat 13. The container 11 includes a bottom wall with an inclined surface 111 to which the heater 12 is connected. The thermostat 13 is mounted to a cylindrical side wall of the container 11 at a portion adjacent to the higher end of the inclined surface 111.

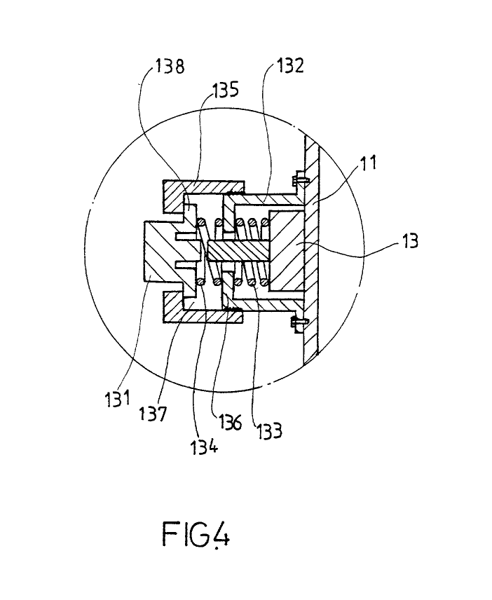

A push button 131 is operably connected to the thermostat 13 to turn on or turn off the water distiller. Referring to FIG. 4, the thermostat 13 is mounted in a room 132 outside the container 11. A first spring 133 is attached between an end wall 136 of the room 132 and the thermostat 13. A cap 135 is mounted outside the room 132 and defines a chamber 137 for receiving a second spring 134 that is attached between the end wall 136 of the room 132 and an enlarged head 138 of the push button 131. The second spring 134 is provided for returning the push button 131 to a position for user's push. The first spring 133 biases the thermostat 13 to be in reliable intimate contact with the cylindrical side wall of the container 11.

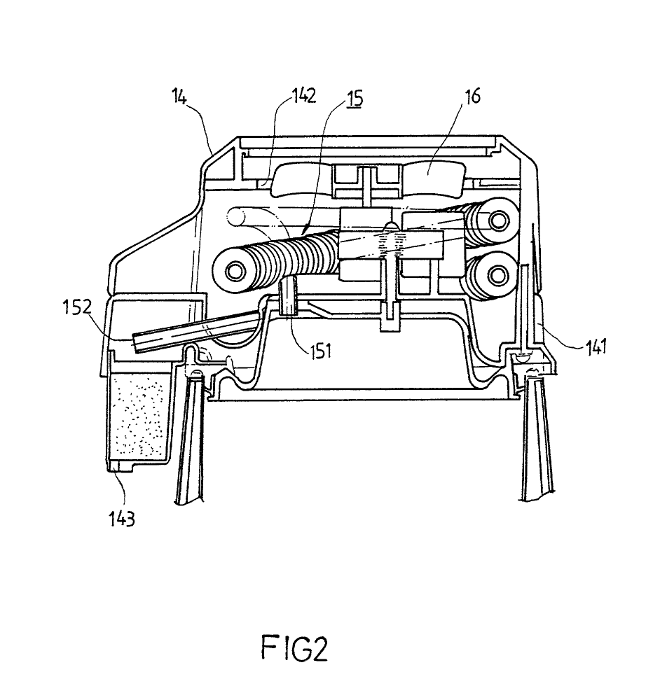

Referring to FIGS. 1 and 2, the cover 14 provides a compartment for receiving the condenser coil 15 and the fan 16. The condenser coil 15 is wound around the fan 16. The cover 15 further includes an air inlet 141, an air outlet 142, and a water outlet 143. Air is drawn into the cover 14 via the air inlet 141 and passes through the condenser coil 15 before it exits via the air outlet 142. Steam generated by means of boiling raw water in the container 11 enters a steam inlet pipe 151 in an end of the condenser coil 15 and exits via the water outlet 143 after passing through a water discharge tube 152 in the other end of the condenser coil 15. The cover 14 is mounted on top of the shell 10 such that the shell 10 and the cover 14 together form an enclosed container.

The container 11 receives raw water which becomes steam after being heated by the heater 12. The steam in the container 11 enters the steam inlet pipe 151 of the condenser coil 15 in the cover 14 and then condenses into distilled water as a result of temperature reduction by the condenser coil 15 and the fan 16. The distilled water flows out of the water distiller via the water outlet 143. When the container 11 is filled with raw water, the heater 12 heats and thus vaporizes the raw water until the thermostat 13 shuts off the power under a condition that the temperature of the container reaches a pre-determined value.

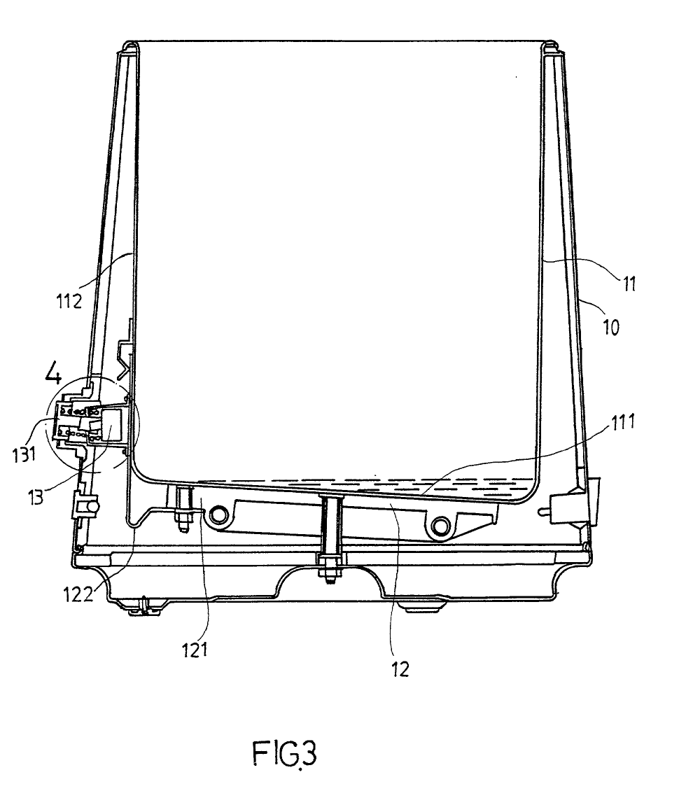

Referring to FIG. 3, when the level of the raw water in the container 11 is lowered to expose the higher end of the inclined surface 111 of the bottom wall of the container 11, the heater 20 still heats the raw water above the lower end of the inclined surface 111, yet the higher end of the inclined surface 111 has a higher rise in the temperature than the lower end of the inclined surface 111, and the heat is conducted to the thermostat 13. The thermostat 13 shuts off the power when it reaches a pre-determined temperature to avoid overheating to the bottom wall of the container 11 that might damage the heater 12 and the container 11. Accordingly, the water distiller in accordance with the present invention avoids the overheating problem encountered in the water distiller of U.S. Pat. No. 4,342,623.

A comparison table 1 is listed as follows to indicate differences between the water distiller (“The invention”) in accordance with the present invention and a conventional water distiller (“Prior art”) under the same input power of 800 W.

TABLE 1

| | Normal Working Status | | Stop Heating Status | |
|---|---|---|---|---|
| | temperature | temperature | temperature | temperature |
| | of thermostat | of heater | of thermostat | of heater |
| Prior art | 100° C. | 160° C. | 117° C. | 230° C. |
| The invention | 100° C. | 160° C. | 117° C. | 180° C. |

The water distiller in accordance with the present invention has an inclined surface in a bottom wall of the container, yet the conventional water distiller has no such arrangement. It is apparent from the above table that the temperatures of the heaters in both water distillers are identical. Nevertheless, when the thermostat reaches a pre-determined temperature of 117° C., the temperature of the heater of the invention is lower than that of the heater of the prior art by 50° C. The container will be seriously damaged as a result of overheating when the temperature of the heater exceeds beyond 200° C. Accordingly, in the conventional water distiller, the conductive silicon layer applied between the heating plate of the heater and the container malfunctions, the heating plate tends to deform, and operation of the thermostat is not satisfactory.

Although the invention has been explained in relation to its preferred embodiment, it is to be understood that many other possible modifications and variations can be made without departing from the spirit and scope of the invention as hereinafter claimed.

What is claimed is:

1. A water distiller comprising:
a shell including a first compartment therein;
a container mounted in the first compartment of the shell and including a bottom wall with an inclined surface, the inclined surface having a higher end;
a heater mounted in the first compartment of the shell and connected to the inclined surface of the bottom wall of the container, the heater including a heating plate for heating the container;
a thermal conductive plate connected to the heating plate of the heater and mounted outside the container;
a thermostat mounted in the first compartment of the shell and connected to the higher end of the inclined surface via the thermal conductive plate for controlling the heater;
a cover mounted on top of the shell to form an enclosed container, the cover including a second compartment;
a condenser coil mounted in the second compartment of the cover; and
a fan mounted in the second compartment of the cover and wound around by the condenser coil;
wherein when a level of raw water in the container is lowered such that the higher end of the bottom wall of the container is exposed, the temperature of the higher end of the bottom wall of the container rises as a result of heating by the heater.

2. A water distiller comprising:
a shell including a first compartment therein;
a container mounted in the first compartment of the shell and including a bottom wall;
a heater mounted in the first compartment of the shell and connected to the bottom wall of the container, the heater being provided for heating the container;
a thermostat mounted in the first compartment of the shell and connected to the container for controlling the heater, the thermostat further including:
a room provided outside the container for receiving the thermostat that senses temperature of the container;
a first spring mounted in the room for biasing the thermostat to be in an intimate contact with the container;
a cap mounted outside the room and defining a chamber;
a push button including a first end outside the cap for manual operation and a second end in the chamber of the cap; and
a second spring mounted in the chamber for biasing the push button to a position for the manual operation;
a cover mounted on top of the shell to form an enclosed container, the cover including a second compartment;
a condenser coil mounted in the second compartment of the cover; and
a fan mounted in the second compartment of the cover and wound around by the condenser coil.
